(19) United States
(12) Patent Application Publication
(10) Pub. No.: US 2019/0380449 A1
(43) Pub. Date: Dec. 19, 2019

(54) Shoe Upper Pad Printing and Moulding System

(71) Applicant: Orisol Taiwan Ltd., Chang Hwa (TW)

(72) Inventor: Yaacov Sadeh, Rechovot (IL)

(73) Assignee: Orisol Taiwan Ltd.

(21) Appl. No.: 16/009,879

(22) Filed: Jun. 15, 2018

(51) Int. Cl. A43D 95/14; B29D 35/12; A43B 23/02; A43B 3/00

(52) U.S. Cl. CPC A43D 95/14; A43B 3/0078; A43B 23/02; B29D 35/126

(57) ABSTRACT

A shoe upper pad printing and moulding system includes a pad printing machine, an imprint device and a turntable. The turntable is provided with a plurality of positioning portions. With the pad printing machine arranged beside the turntable, and the turntable serving to carry the object, it only needs to micro-adjust the processing positions of the pad printing machine and the imprint device before processing to align the pad printing position and the imprint position with the same parts of the positioning portions, the pad printing position and the imprint position can accurately fall in the same parts of the object during processing, so that the yield of finished products can be improved and labor and time costs can be reduced.

### BACKGROUND

### Field of the Invention

The present invention relates to a shoe upper processing system, and more particularly to a shoe upper pad printing and moulding system.

### Related Prior Art

Most of the shoe uppers are printed with different printings, such as brand logo or beautiful patterns, and the aforementioned printing is not only a single two dimensional pattern, but a three-dimensional printing with both a pattern and a bump shape. However, the three dimensional printings on the shoe upper must go through at least two procedures, generally, a transfer printing step is carried out first, and then a hot stamping step is performed to form a three dimensional printing on the upper of the shoe.

The hot stamping die must be pressed precisely on the peripheral edge of the printing pattern, so that the printing pattern and the bump shape can be matched. If there is a slight error, the effect of hot stamping will not be good. Therefore, the position of transfer and stamping in the finished product must be very accurate.

The conventional upper printing and moulding require manual work, and more rely on experienced staff to proofread by experience. However, the accuracy of proofreading with naked eyes is very limited, and the good production rate can not be effectively improved. Therefore, it is urgent to have a systematic and automatic upper printing and moulding system.

### SUMMARY

One objective of the present invention is to provide a shoe upper pad printing and moulding system capable of improving the processing accuracy and the yield of finished products.

Another objective of the invention is to the labor and time costs.

To achieve the above objectives, a shoe upper pad printing and moulding system accordance with the invention, comprises:

a pad printing machine including a pad printer which includes: an ink cup mould, a transfer plate mould, and a pad printing mould, the ink cup mould including an ink-cup rack and an ink cup disposed on the ink-cup rack, wherein the ink-cup rack is able to move back and forth repeatedly along a direction, the ink cup is used to store ink;
the transfer plate mould includes a transfer plate which includes a transfer section and a standby section, the ink cup is located on a surface of the transfer plate, and repeatedly movable between the transfer section and the standby section, when the ink cup moves to the transfer section, the ink will be poured into the transfer section from the ink cup;
the pad printing mould includes a two dimensional drive device and a pad printing head which is fixed to and driven to move by the two dimensional drive device;

a turntable unit including a turntable drive group and a turntable, wherein the pad printing machine is arranged beside the turntable, the turntable includes a plurality of positioning portions provided for carrying an object, the turntable drive group drives the turntable to rotate;

a high frequency machine provided for outputting a high frequency current; and

an imprint device electrically connected to the high frequency machine to receive the high frequency current, wherein the imprint device is located beside the turntable and includes: an imprint frame, an upper mould drive mechanism, and a mould mounting mechanism, the upper mould drive mechanism is fixed in the imprint frame, the upper mould drive mechanism is connected to and drives the mould mounting mechanism to move toward or away from the turntable, the mould mounting mechanism is provided for mounting a mould, thermal energy generated by the high frequency current is transmitted to the mould via the mould mounting mechanism;

by such arrangements, the pad printing head is driven by the two dimensional drive device to move to the transfer section to dip into the ink, and then moved by the two dimensional drive device to the positioning portions to print the ink onto the object, and then the turntable unit moves the object which has been printed with ink to allow the mould to perform imprinting.

The invention further provides another shoe upper pad printing and moulding system which comprises:

a pad printing machine including a pad printer which includes: a transfer plate mould, and a pad printing mould, the pad printing mould including a transfer plate for providing an ink, the pad printing mould including a two dimensional drive device and a pad printing head which is fixed to and driven by the two dimensional drive device to move to the transfer plate to dip into the ink;

a high frequency machine including a high frequency generating system and a cooling device, wherein the high frequency generating system includes a high frequency generating device and a high frequency output member, and serves to produce high frequency waves which are outputted from the high frequency output member;

an imprint device including an imprint frame, an upper mould drive mechanism, an upper mould adjustment mechanism, a mould mounting mechanism, a lower mould drive mechanism and a lower mould assembly, wherein the upper and lower mould drive mechanisms are fixed in the imprint frame, the upper mould drive mechanism is connected to and drives the upper mould adjustment mechanism to move along a height direction, the upper mould adjustment mechanism is connected to the mould mounting mechanism and capable of adjusting a position of the mould mounting mechanism with respect to the upper mould drive mechanism;
the mould mounting mechanism includes a heating plate and a mould mounting plate, the heating plate is connected to the high frequency output member, the mould mounting plate is removably fixed to the heating plate and provided for mounting different moulds;
the lower mould drive mechanism is drivingly connected to and drives the lower mould assembly to move towards the mould mounting mechanism; and

a turntable unit including a turntable drive group and a turntable, wherein the pad printing machine is arranged beside the turntable, the turntable includes a plurality of positioning portions provided for carrying an object, and the turntable drive group drives the turntable to rotate.

It can be learned from the above that with the pad printing machine arranged beside the turntable, and the turntable serving to carry the object, it only needs to micro-adjust the processing positions of the pad printing machine and the imprint device before processing to align the pad printing position and the imprint position with the same parts of the positioning portions, the pad printing position and the imprint position can accurately fall in the same parts of the object during processing, so that the yield of finished products can be improved and labor and time costs can be reduced.

Besides, by controlling the pad printing mechanism through the controller, the pad printing position can accurately fall in the same parts of the object during processing, the pad printing time and the waiting time for each pad printing are the same, and the process for each pad printing is the same, so as to achieve the goal of standardization and ensure the quality of pad printing.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a perspective view of a shoe upper pad printing and moulding system in accordance with the invention;

FIG. 2 is a perspective view of a part of the shoe upper pad printing and moulding system in accordance with the invention;

FIG. 3 is an exploded view of the shoe upper pad printing and moulding system in accordance with the invention;

FIG. 4 is a side view of the shoe upper pad printing and moulding system in accordance with the invention;

FIG. 5 is an exploded view of the turntable unit of the shoe upper pad printing and moulding system in accordance with the invention;

FIG. 6 is an illustrative view of the controller of the shoe upper pad printing and moulding system in accordance with the invention;

FIG. 7 is an illustrative view of the invention showing that the display device is displaying information;

FIG. 8 is an illustrative view of the invention showing that the display device is displaying information;

FIG. 9 is an illustrative view of the invention showing that the display device is displaying information;

FIG. 10 is an exploded view of an imprint device of the shoe upper pad printing and moulding system in accordance with the invention;

FIG. 11 is a perspective view of a part of the imprint device of the shoe upper pad printing and moulding system in accordance with the invention;

FIG. 12 is a side view of the mould mounting mechanism of the imprint device of the invention;

FIG. 13 is an illustrative view of the lower mould drive mechanism and the lower mould assembly of the shoe upper pad printing and moulding system in accordance with the invention;

FIG. 14 is a perspective view showing the imprint device and the mould mounting mechanism of the shoe upper pad printing and moulding system in accordance with the invention;

FIG. 15 is an exploded view showing the imprint device and the mould mounting mechanism of the shoe upper pad printing and moulding system in accordance with the invention;

FIG. 16 is a perspective view of the high frequency machine of the shoe upper pad printing and moulding system in accordance with the invention;

FIG. 17 is an illustrative view of the invention showing that the high frequency machine is connected to the imprint device;

FIG. 18 is an operational view of the pad printing mechanism of the shoe upper pad printing and moulding system in accordance with the invention;

FIG. 19 is an operational view of the pad printing mechanism of the shoe upper pad printing and moulding system in accordance with the invention;

FIG. 20 is an operational view of the pad printing mechanism of the shoe upper pad printing and moulding system in accordance with the invention;

FIG. 21 is an operational view of the pad printing mechanism of the shoe upper pad printing and moulding system in accordance with the invention; and

FIG. 22 is an operational view of the pad printing mechanism of the shoe upper pad printing and moulding system in accordance with the invention;

### DETAILED DESCRIPTION

The present invention will be clearer from the following description when viewed together with the accompanying drawings, which show, for purpose of illustrations only, the preferred embodiment in accordance with the present invention.

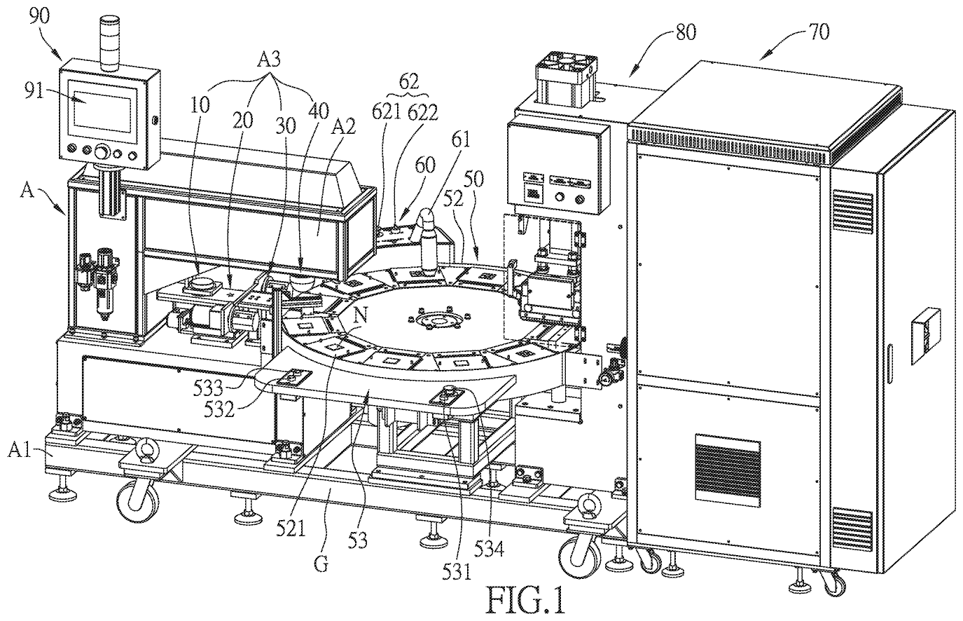

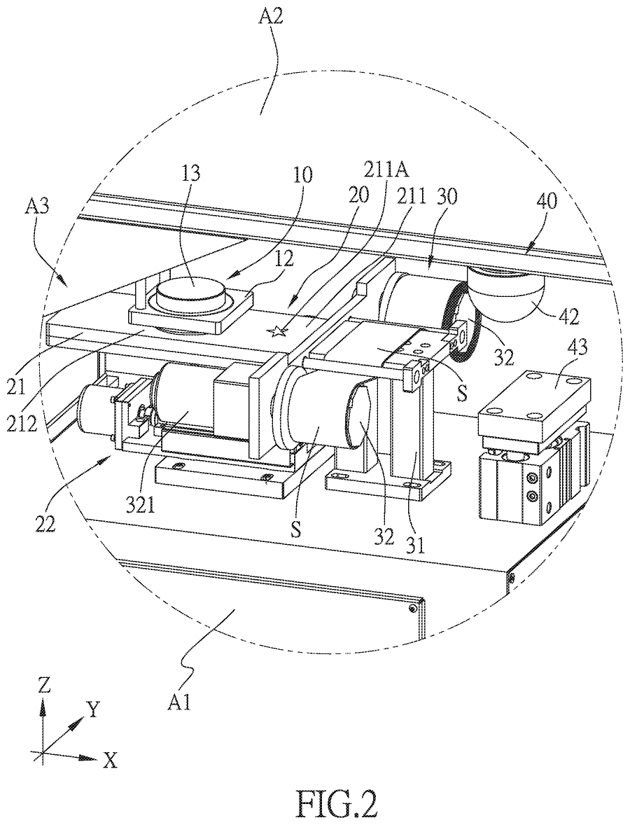

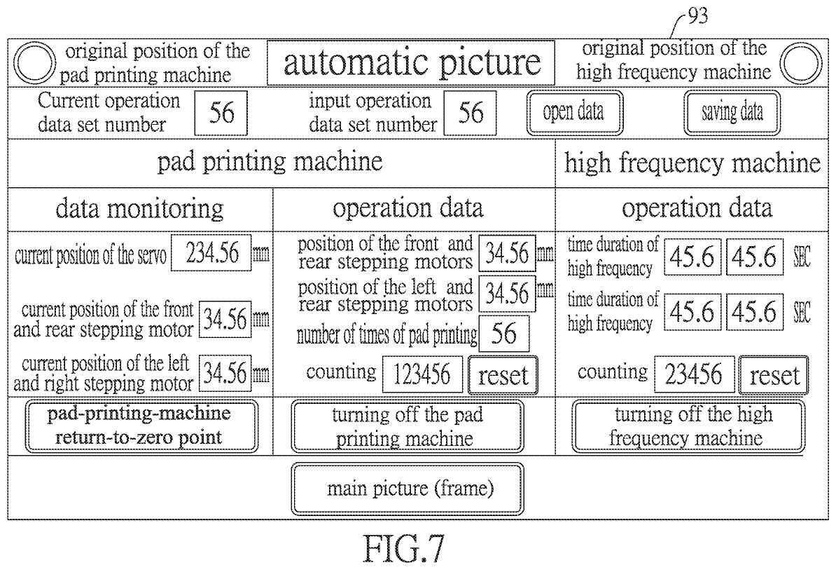

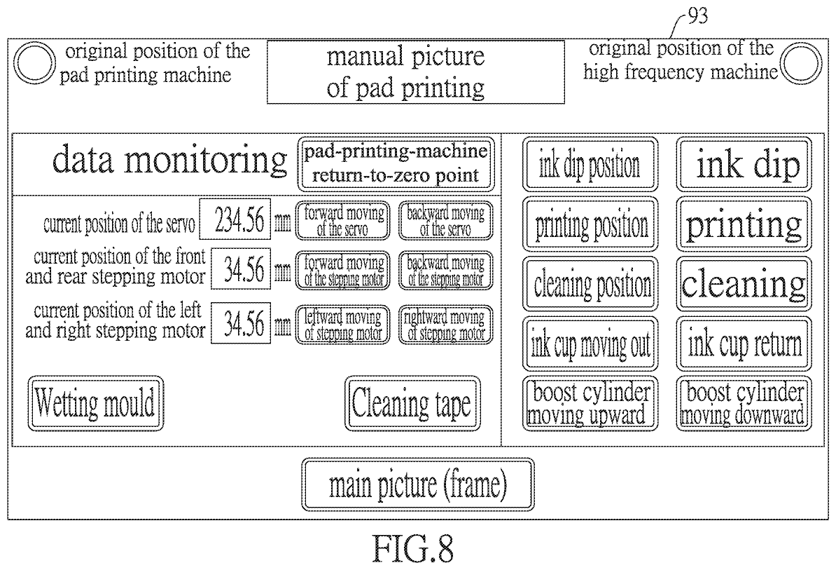

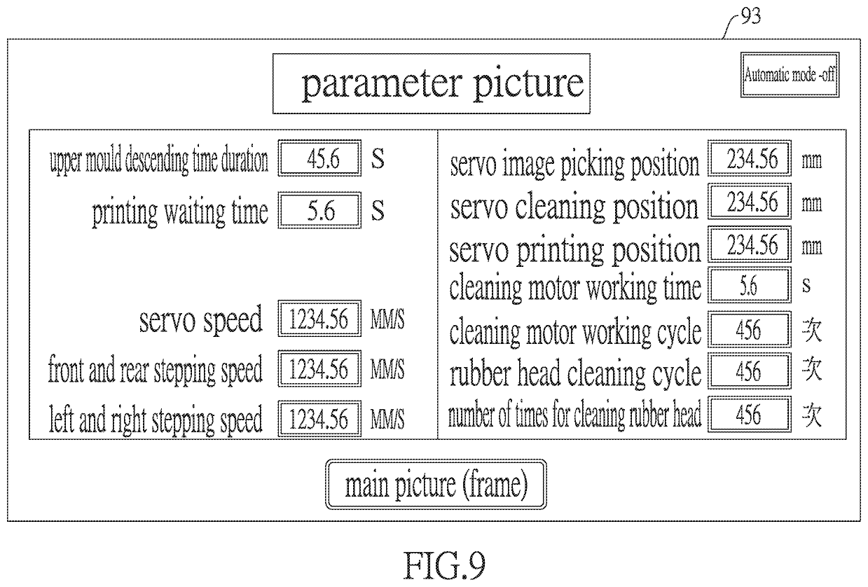

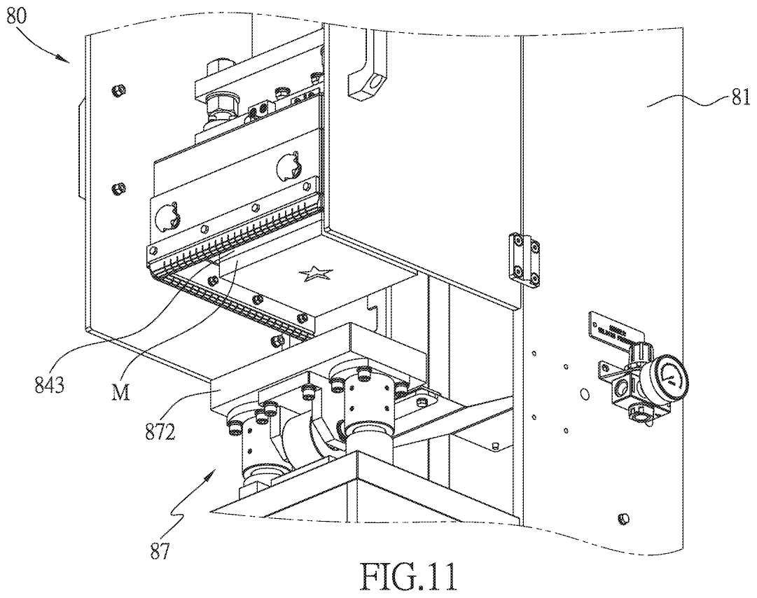

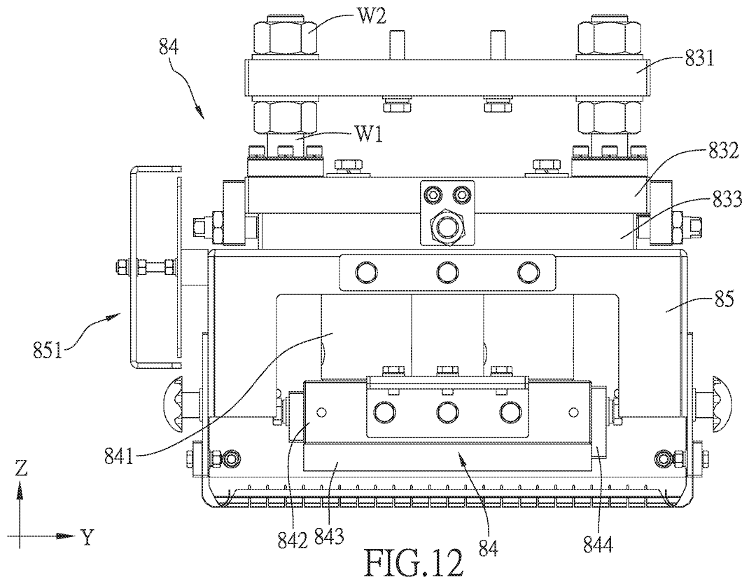

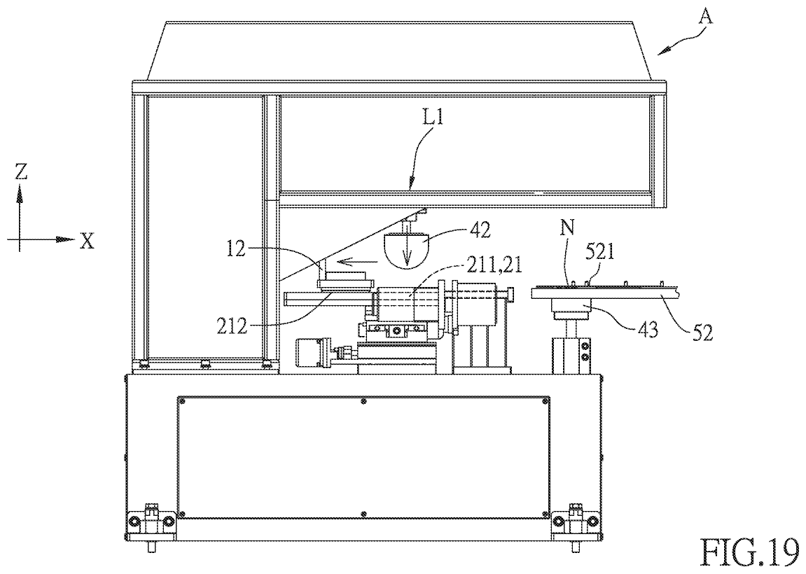

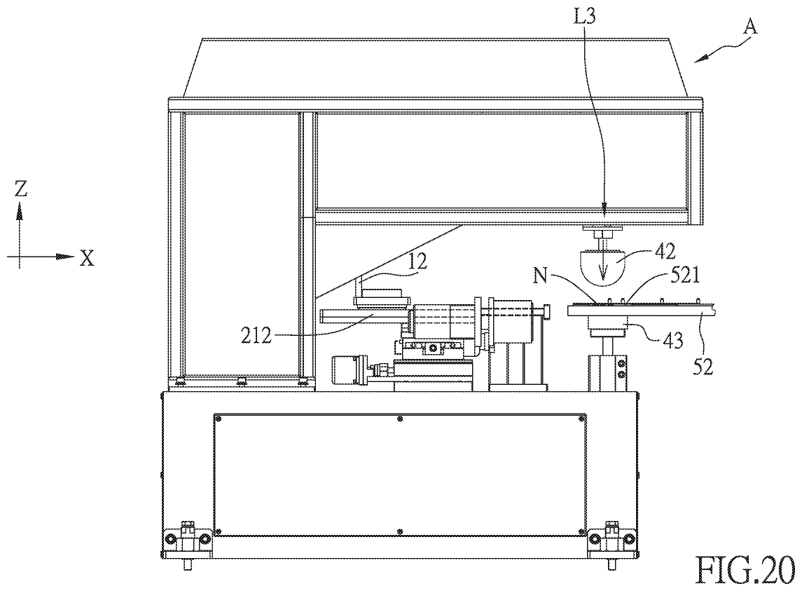

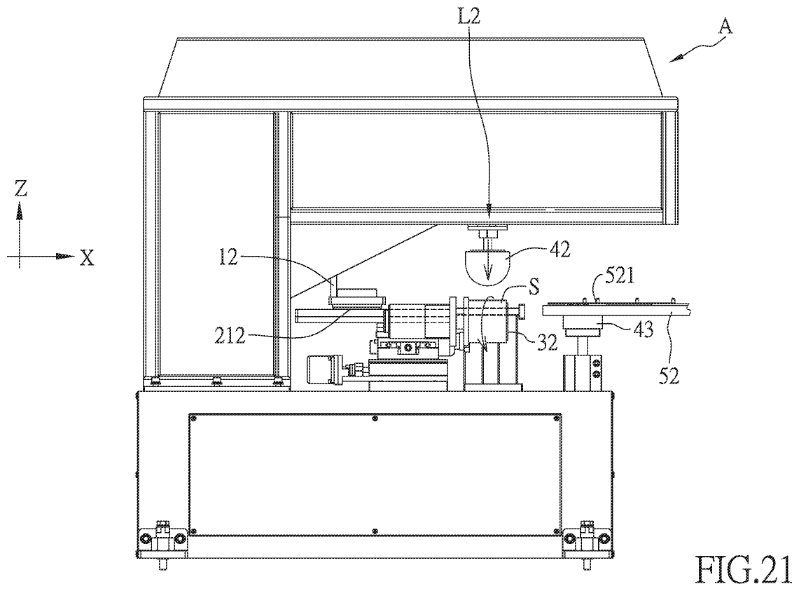

Referring to FIGS. 1-22, a shoe upper pad printing and moulding system in accordance with the invention comprises:

A pad printing machine A comprises: a bottom frame A1, and a base frame A2 and a pad printer A3 which are mounted on the bottom frame A1. The pad printer A3 includes: an ink cup mould 10, a transfer plate mould 20, a cleaning mould 30 and a pad printing mould 40. The ink cup mould 10 is mounted on the base frame A2 and includes: a drive motor 11, an ink-cup rack 12 driven by the drive motor 11, and an ink cup 13 disposed on the ink-cup rack 12. The drive motor 11 is fixed to the base frame A2. The ink-cup rack 12 is drivingly connected to the drive motor 11. The ink cup 13 is used to store ink. The transfer plate mould 20 includes a transfer plate 21 and a three dimensional correction device 22. A direction along which the transfer plate 21 extends is defined a transverse direction X, and the ink-cup rack 12 is driven by the drive motor 11 to move back and forth repeatedly along the transverse direction X. The transfer plate 21 is located at one side of the three dimensional correction device 22 and is driven to move by the three dimensional correction device 22. The three dimensional correction device 22 is capable adjusting a position of the transfer plate 21 along the transverse direction X and a longitudinal direction Y perpendicular to the transverse direction X, and also capable of adjusting rotation of the transfer plate 21. The transfer plate 21 includes a transfer section 211 and a standby section 212 which are located in different parts of the transfer plate 21 along the transverse direction X. In this embodiment, the transfer section 211 is a concave die, therefore is formed with a cavity 211A for storage of ink. The cavity 211A can be formed in different shapes according to different needs. The ink cup 13 is located on the surface of the transfer plate 21 where the cavity 211A is located, and repeatedly movable between the transfer section 211 and the standby section 212. The ink cup 13 is normally located in the standby section 212, and when the ink cup 13 moves to the transfer section 211, the ink will be poured into the cavity 211A from the ink cup 13. In this embodiment, the three dimensional correction device 22 includes a transverse displacement table 221, a longitudinal displacement table 222 and a rotation micro-adjustment table 223 which are arranged in a stacked manner. The transverse displacement table 221 includes a first fixing portion 221A, a first slide portion 221B and a first drive device 221C. The first fixing portion 221A is fixed to the top of the bottom frame A1, the first slide portion 221B is able to move with respect to the first fixing portion 221A along the transverse direction X, and the first drive device 221C is drivingly connected to and drives the first slide portion 221B to move along the transverse direction X. The longitudinal displacement table 222 is fixed to the first slide portion 221B, and includes: a second fixing portion 222A, a second slide portion 222B and a second drive device 222C. The second fixing portion 222A is fixed to the first slide portion 221B, the second slide portion 222B is able to move with respect to the second fixing portion 222A along the longitudinal direction Y, and the second drive device 222C is drivingly connected to and drives the second slide portion 222B to move along the longitudinal direction Y. The rotation micro-adjustment table 223 is mounted on the second slide portion 222B, and includes: a base portion 223A and a rotary portion 223B rotatable with respect to the base portion 223A. The base portion 223A is fixed to the second slide portion 222B, and the transfer plate 21 is mounted on the rotary portion 223B. The configuration of the three dimensional correction device 22 described above is one of the embodiments of the present invention, and not intended to limit the invention. The cleaning mould 30 includes: a stationary platform 31 mounted on the bottom frame A1, and two rollers 32 disposed at two sides of the stationary platform 31 along the longitudinal direction Y in a pivotable manner. One of the rollers 32 is drivingly connected to and driven to rotate by a drive source 321. The two rollers 32 are provided for mounting of a cleaning tape S in such a manner that the cleaning tape S extends from one of the rollers 32 to the stationary platform 31 and then is connected to another of the rollers 32. The pad printing mould 40 includes: a two dimensional drive device 41, a pad printing head 42 and a support seat 43. The two dimensional drive device 41 is fixed to the base frame A2, and the pad printing head 42 is fixed to and driven to move by the two dimensional drive device 41. A direction extending from the pad printing head 42 to the transfer plate 21 is defined as a height direction Z which is perpendicular both to the transverse direction X and the longitudinal direction Y, and the two dimensional drive device 41 is capable of driving the pad printing head 42 to move along the transverse direction X or the height direction Z. In this embodiment, the two dimensional drive device 41 includes a transverse drive mechanism 411 and a height drive mechanism 412. The transverse drive mechanism 411 includes: a transverse drive source 411A and a transverse displacement device 411B drivingly connected to and driven by the transverse drive source 411A to move along the transverse direction X. The height drive mechanism 412 is fixed to the transverse displacement device 411B, the pad printing head 42 is fixed to and driven by the height drive mechanism 412 to move back and forth repeatedly along the height direction Z. The support seat 43 is mounted on the bottom frame A1, so that the stationary platform 31 is located between the support seat 43 and the transfer plate 21 along the transverse direction X.

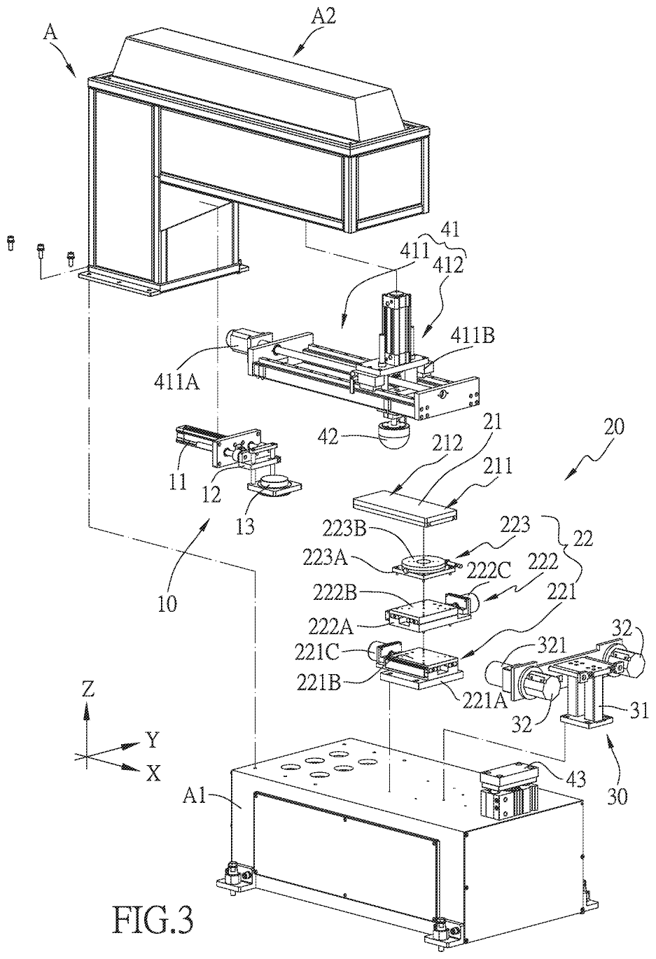

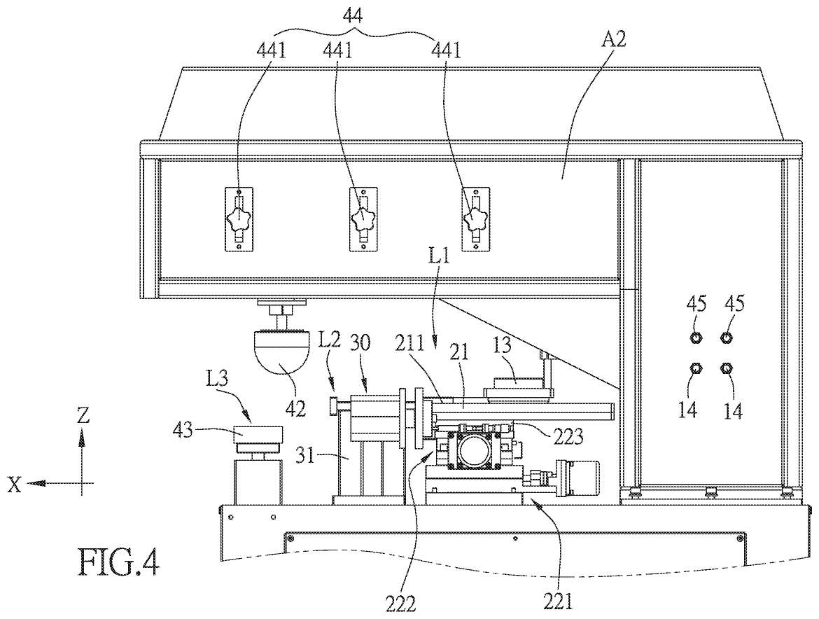

In this embodiment, as shown in FIGS. 3 and 4, the pad printing mould 40 further includes a travel micro-adjustment device 44 fixed to the base frame A2. A position of the transfer section 211 of the transfer plate 21 in the transverse direction X is defined as an ink dip position L1, a position of the stationary platform 31 in the transverse direction X is defined as a cleaning position L2, a position of the support seat 43 in the transverse direction X is defined as a pad printing position L3, the travel micro-adjustment device 44 is signally connected to the two dimensional drive device 41 to control the displacement (namely descending amount) of the pad printing head 42 in the ink dip position L1, in the cleaning position L2 or in the pad printing position L3 along the height direction Z. Preferably, the travel micro-adjustment device 44 includes three knobs 441, the first one of the three knobs 441 controls the displacement amount of the pad printing head 42 in the ink dip position L1 along the height direction Z, the second one of the three knobs 441 controls the displacement amount of the pad printing head 42 in the cleaning position L2 along the height direction Z, and the third one of the three knobs 441 controls the displacement amount of the pad printing head 42 in the pad printing position L3 along the height direction Z.

In the preferred embodiment, as shown in FIGS. 3 and 4, the pad printing mould 40 further includes a pad-printing head speed micro-adjustment device 45 which is fixed on the base frame A2 and signally connected to the height drive mechanism 412 to control the speed of upward or downward displacement of the pad printing head 42.

In a preferred embodiment, as shown in FIGS. 3 and 4, the ink cup mould 10 further includes an ink-cup rack speed micro-adjustment device 14 which is fixed on the base frame A2 and signally connected to the drive motor 11 to control the displacement speed of the ink-cup rack 12 along the transverse direction X.

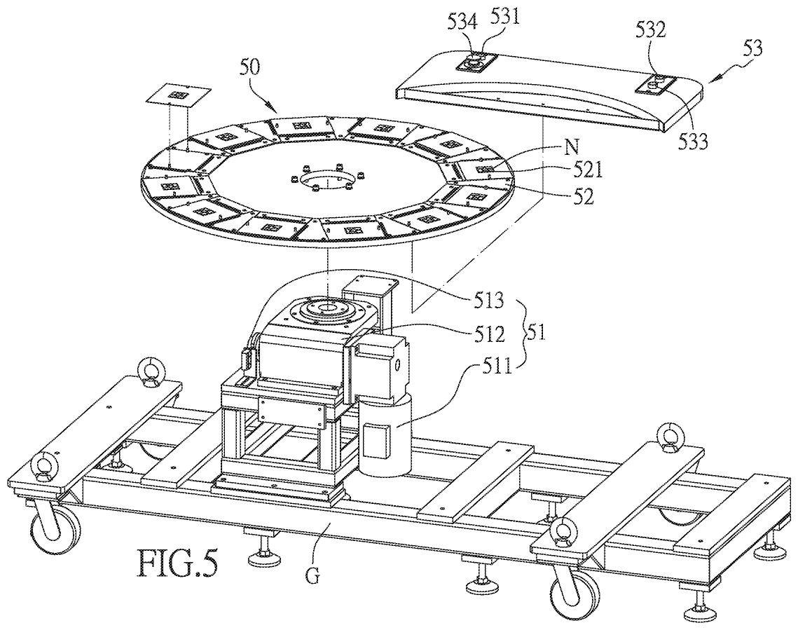

A turntable unit 50, as shown in FIG. 5, includes: a turntable drive group 51, a turntable 52 and a control group 53. The turntable drive group 51 includes: a turntable drive source 511, a position splitter 512 and a stroke switch 513. The stroke switch 513 and the position splitter 512 are signally connected to the turntable drive source 511. The pad printing machine A is arranged beside the turntable 52 which is a circular disc. The turntable 52 includes a plurality of positioning portions 521 provided for carrying an object N, and is signally connected to the turntable drive group 51. The turntable drive source 511 drives the turntable 52 to rotate. The position splitter 512 controls the rotation angle at which the turntable 52 rotates each time, so that each time the turntable 52 rotates, there will be one positioning portion 521 aligned to the position of the support seat 43 of the pad printing machine A. The stroke switch 513 controls the turntable 52 to rotate or stop, so that the turntable 52 will stop for a fixed period of time after each rotation. In this embodiment, the positioning portions 521 are grooves, the control group 53 is signally connected to the turntable drive group 51 to control the turntable drive group 51 to start or stop. Preferably, the control group 53 includes a first start button 531, a second start button 532, a reset button 533 and a stop button 534. The first start button 531 and the second start button 532 are pressed simultaneously to turn on the turntable drive source 511 to rotate the turntable 52. The stop button 534 turns off the turntable drive source 511 to control the turntable 52 to stop rotating, and the reset button 533 serves to re-rotate the turntable 52 after emergency stop of the turntable 52 or an abnormal alarm.

A hot air generator group 60, as shown in FIG. 1, is disposed nearby the turntable unit 50, and includes: at least one hot air generator 61 and at least one control button unit 62. The number of the control button unit 62 is the same as the number of the hot air generator 61. The hot air generator 61 serves to blow hot air to the positioning portions 521 of the turntable 52 so that the ink on the object N which has been pad printed can be dried quickly. The control button unit 62 serves to turn on or off the hot air generator 61 or to adjust the temperature of the hot air generated by the hot air generator 61. In this embodiment, the control button unit 62 includes a switch button 621 to turn on and off the hot air generator 61, and a temperature regulating button 622 to adjust the temperature of the hot air generated by the hot air generator 61.

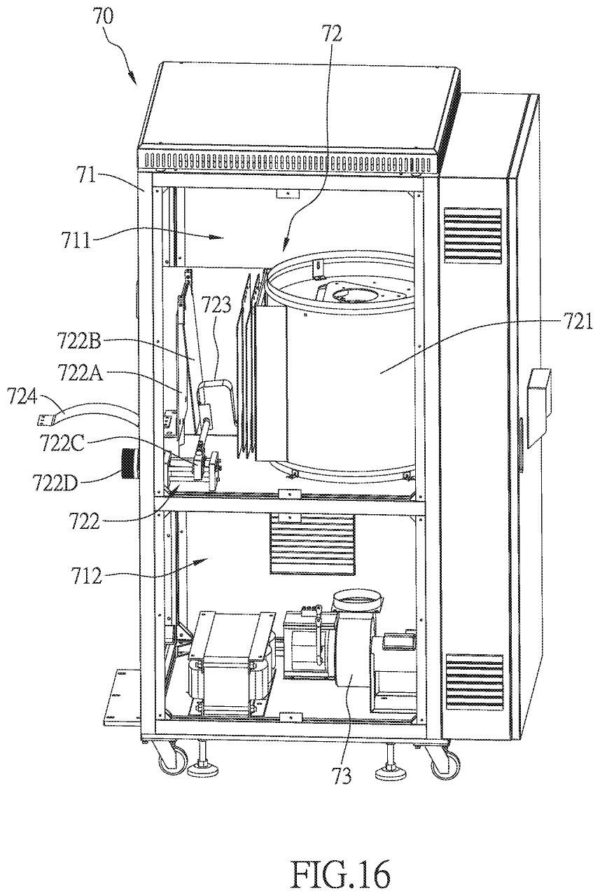

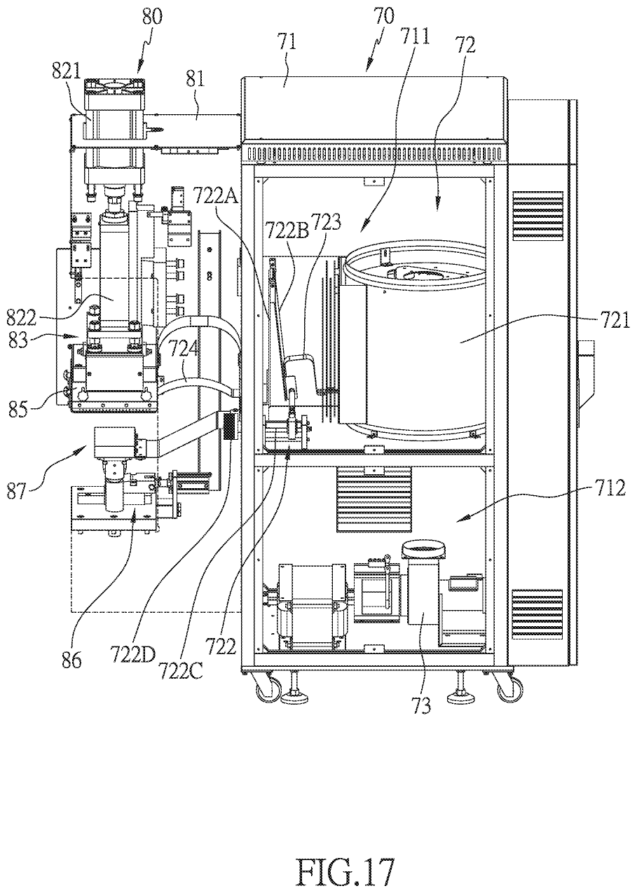

A high frequency machine 70, as shown in FIGS. 16 and 17, includes a housing 71, a high frequency generating system 72 and a cooling device 73. The housing 71 includes a first space 711 and a second space 712. The high frequency generating system 72 is disposed in the first space 711, and the cooling device 73 is disposed in the second space 712. In this embodiment, the cooling device 73 is a fan to cool off the high frequency generating system 72. The high frequency generating system 72 includes a high frequency generating device 721, an adjustment device 722, a conduction member 723 and a high frequency output member 724. The high frequency generating device 721 is a high frequency bucket to produce high frequency waves. The conduction member 723 is connected to the high frequency generating device 721 and the adjustment device 722, and serves to transmit the high frequency waves generated by the high frequency generating device 721 to the adjustment device 722. The adjustment device 722 includes: an output capacitor plate 722A, an adjustable capacitor plate 722B, a mobile device 722C and a handwheel 722D. The output capacitor plate 722A is fixed to the housing 71, the handwheel 722D is connected to and drives the mobile device 722C to move linearly, the adjustable capacitor plate 722B is fixed to the mobile device 722C, and the conduction member 723 is connected to the adjustable capacitor plate 722B. By rotating the handwheel 722D, the adjustable capacitor plate 722B is controlled to move close to or away from the output capacitor plate 722A, thereby controlling the output energy of the output capacitor plate 722A. The high frequency output member 724 is connected to the output capacitor plate 722A of the adjustment device 722 to output a high frequency current.

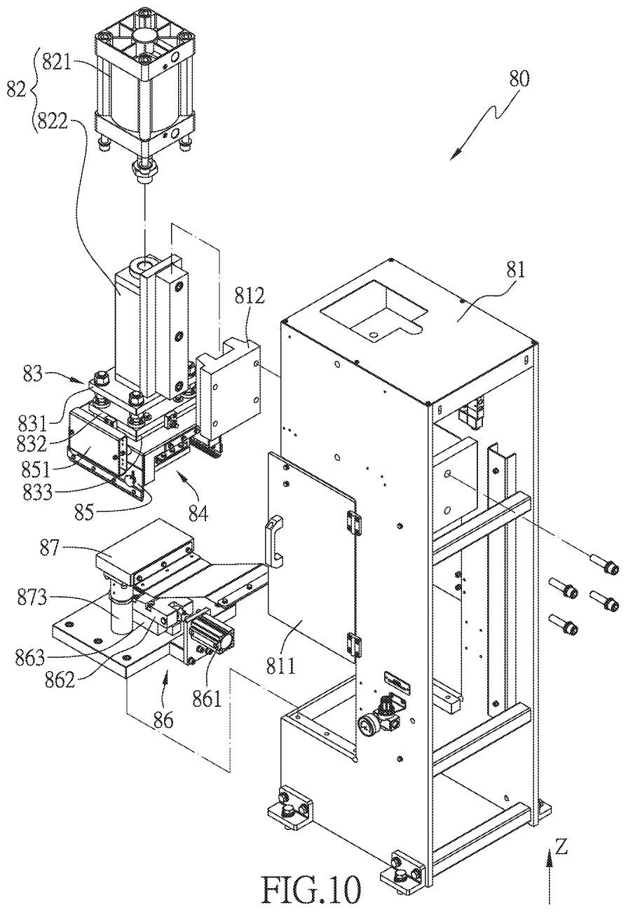

An imprint device 80 is electrically connected to the high frequency machine 70 and located beside the turntable 52, as shown in FIGS. 10-15 and 17, includes: an imprint frame 81, an upper mould drive mechanism 82, an upper mould adjustment mechanism 83, a mould mounting mechanism 84, a cover 85, a lower mould drive mechanism 86, and a lower mould assembly 87. The imprint frame 81 is provided with a safety gate 811 at two opposite sides thereof, which can be opened and closed by the user. The upper and lower mould drive mechanisms 82, 86 are fixed in the imprint frame 81. The upper mould drive mechanism 82 is connected to and drives the upper mould adjustment mechanism 83 to move along the height direction Z, and the upper and lower mould drive mechanisms 82, 86 are located in different positions in the direction of the height direction Z. The upper mould drive mechanism 82 includes a drive source 821 and a guide block 822 connected to and driven to move by the drive source 821. The imprint frame 81 includes a guide rail 812, and the guide block 822 is slidably mounted on the guide rail 812 and able to move in the height direction Z. The upper mould adjustment mechanism 83 is fixed to the guide block 822, and includes: a first plate 831, a second plate 832 and a third plate 833. The second plate 832 is connected to and movable with respect to the first plate 831 along the height direction Z, thus micro-adjusting the position of the second plate 832 in the height direction Z. In this embodiment, an adjustment bolt W1 is inserted through the first plate 831 and the second plate 832 and screwed with an adjustment nut W2, by rotating the adjustment nut W2 can adjust the position of the second plate 832 in the height direction Z. The second plate 832 is fixed to the third plate 833 and movable with respect to the third plate 833 along the transverse and longitudinal directions X, Y. The third plate 833 is fixed to the mould mounting mechanism 84 and the cover 85, so that the upper mould adjustment mechanism 83 can micro-adjust the relative position between the mould mounting mechanism 84 and the upper mould drive mechanism 82. Besides, the cover 85 is further provided with a wave filtering group 851 which consists of capacitors in this embodiment.

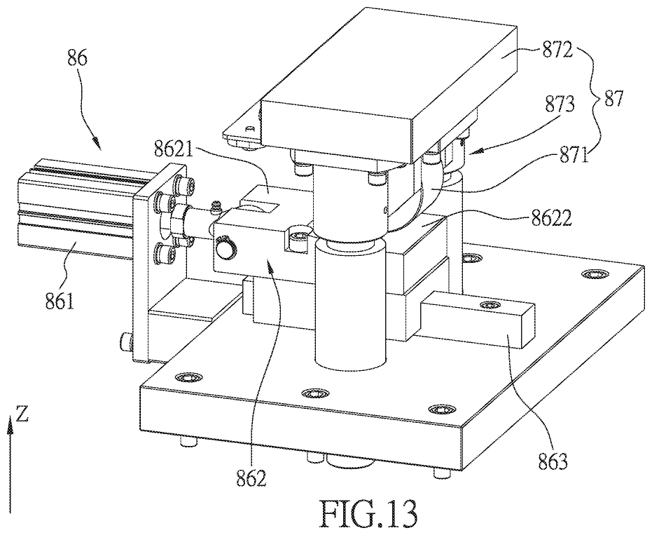

The mould mounting mechanism 84 includes a plurality of insulation cylinders 841, a heating plate 842, a mould mounting plate 843 and a protection baffle 844. The insulation cylinders 841 are connected to the heating plate 842 and the third plate 833. The heating plate 842 is connected to the high frequency output member 724 to receive and convert high frequency current into heat energy. The heating plate 842 includes two quick release pins 8421, and each of the quick release pins 8421 includes a neck portion 8421A and a head portion 8421B which has a diameter larger than a diameter of the neck portion 8421A. The mould mounting plate 843 is removably fixed to the heating plate 842, and includes two elongated quick release holes 8431. Each of the quick release holes 8431 includes an engaging portion 8431A formed on an inner lateral surface of the quick release holes 8431 to form a stepped structure with respect to the inner lateral surface of the quick release holes 8431. When the mould mounting plate 843 is fixed to the heating plate 842, the quick release pins 8421 are inserted in the quick release holes 8431. By moving the mould mounting plate 843, the head portions 8421B of the quick release pins 8421 can be engaged in the engaging portions 8431A, so as to achieve a quick release function, and the mould mounting plate 843 is provided for mounting different moulds M. The protection baffle 844 is fixed to the heating plate 842 by a bolt 8441, and includes: a slide slot 8442, and the bolt 8441 is inserted in the slide slot 8442. The slide slot 8442 includes an insertion portion 8442A and a slide portion 8442B which is different in size from the insertion portion 8442A, so that the protection baffle 844 can rotate while moving. When the mould mounting plate 843 is assembled to the heating plate 842, as shown in FIG. 13, the protection baffle 844 will be maintained in a vertical manner and abutted against the mould mounting plate 843 and the heating plate 842 simultaneously. To remove the mould mounting plate 843, the user can rotate the protection baffle 844 to make the protection baffle 844 abutted against the heating plate 842 only, so that the mould mounting plate 843 can be removed. The protection baffle 844 provides a further protection during assembling and disassembling of the mould mounting plate 843. The cover 85 covers the mould mounting mechanism 84.

Referring to FIG. 13, the lower mould drive mechanism 86 is drivingly connected to and drives the lower mould assembly 87 to move towards the mould mounting mechanism 84, and includes: a boost cylinder 861, a push block 862 and a slide rail 863. The boost cylinder 861 is connected to and drives the push block 862 to move linearly. The slide rail 863 is fixed to the imprint frame 81. The push block 862 is movably mounted on the slide rail 863, and includes: a first section 8621 and a second section 8622. The lower mould assembly 87 includes: a roller 871, a lower mould plate 872 and two telescopic rods 873. The roller 871 is pivoted to the lower mould plate 872 and comes into contact with one surface of the push block 862 which has another opposite surface attached to the slide rail 863. Each of the two telescopic rods 873 has two ends fixed to the imprint frame 81 and the lower mould plate 872, respectively. The boost cylinder 861 moves the push block 862 until the first section 8621 comes into contact with the rollers 871, then the roller 871 pushes the lower mould plate 872 upward, meanwhile, the two telescopic rods 873 also extend. When the second section 8622 contacts the roller 871, the roller 871 will pull the lower mould plate 872 to move downward, so that the two telescopic rods 873 will retract.

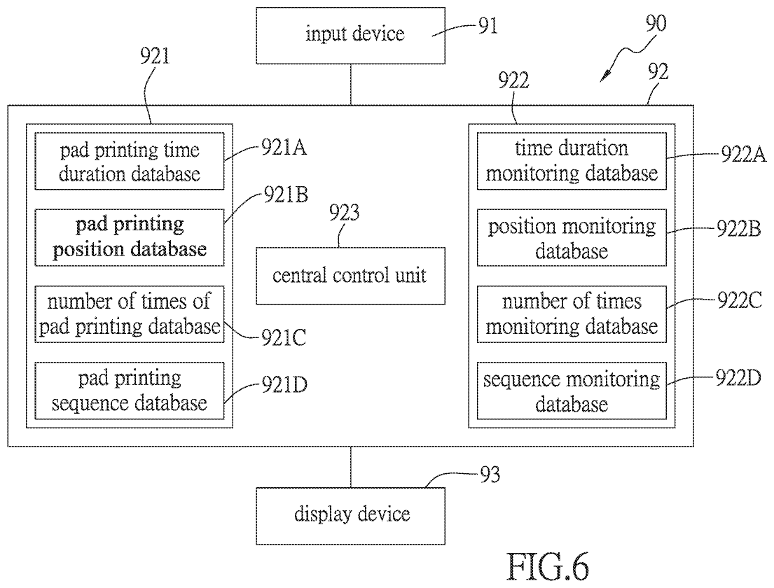

A controller 90, as shown in FIG. 6, is signally connected to the pad printer A3 and includes: an input device 91, a control device 92 and a display device 93. The input device 91 and the display device 93 are signally connected to the control device 92. The input device 91 allows the user to input a preset position information, a preset time duration information, a preset number of times information and a preset sequence information. The preset position information contains coordinates of a pad printing position L3, a cleaning position L2, and the ink dip position L1. The pad printing position L3 refers to the pad printing head 42 corresponding to the object N, the cleaning position L2 refers to a position of the pad printing head 42 corresponding to the cleaning tape S, and the ink dip position L1 refers to a position of the pad printing head 42 corresponding to the transfer section 211. The preset time duration information contains the time duration in which the pad printing head 42 descends and waits, the preset number of times information contains the number of times of pad printing that the pad printing head 42 performs, and the preset sequence information contains the sequence in which the pad printing, the ink dipping and the cleaning are performed. The control device 92 includes a storage unit 921, a monitoring unit 922 and a central control unit 923. The storage unit 921 and the monitoring unit 922 are signally connected to the central control unit 923. The storage unit 921 is signally connected to the input device 91 and includes: a pad printing time duration database 921A, a pad printing position database 921B, a number of times of pad printing database 921C and a pad printing sequence database 921D. The pad printing time duration database 921A is used to store the preset time duration information, the pad printing position database 921B is used to store the preset position information, the number of times of pad printing database 921C is used to store the preset number of times information, and the pad printing sequence database 921D stores the preset sequence information. The monitoring unit 922 includes a time duration monitoring database 922A, a position monitoring database 922B, a number of times monitoring database 922C and a sequence monitoring database 922D. The time duration monitoring database 922A contains an actual time information which refers to a time duration in which the pad printing head 42 descends and waits during pad printing. The position monitoring database 922B contains an actual position information which refers to the position where the pad printing head 42 moved to during pad printing. The number of times monitoring database 922C contains an actual number of times information which refers to the actual number of times of pad printing that the pad printing head 42 performed. The sequence monitoring database 922D contains an actual sequence information which refers to the sequence in which the pad printing head 42 performs the operations (such as ink dipping first, then pad printing, and then cleaning). The central control unit 923 is signally connected to the ink cup mould 10, the cleaning mould 30 and the pad printing mould 40. By referring to the actual position information, the central control unit 923 controls the pad printing mould 40 to make the position that the pad printing head 42 moves close to the coordinates of the ink dip position L1, the cleaning position L2 or the printing position L3 contained in the preset position information. By referring to the actual time duration information, the central control unit 923 controls the pad printing mould 40 to make the time duration in which the pad printing head 42 descends and waits close to the preset time duration information. The central control unit 923 compares the preset number of times information with the actual number of times information, if the preset number of times information conforms with the actual number of times information, the central control unit 923 performs the corresponding subsequent operations, such as alerting, suspending operation, etc. The central control unit 923 enables the ink cup mould 10, the cleaning mould 30 and the pad printing mould 40 to operate in the same sequence as the preset sequence information. The display device 93 is signally connected to the storage unit 921 and the monitoring unit 922, and used to display the preset position information, the preset time duration information, the preset number of times information, the preset sequence information, the actual position information, the actual time duration information, the actual number of times information, and the actual sequence information.

A support frame G as shown in FIGS. 1 and 5, is placed on a plane in a movable or stationary manner, and the pad printing machine A, the turntable unit 50 and the imprint device 80 are mounted on the support frame G for ease of movement, handling and modularization.

What mentioned above are the structural relations of the main components of the present invention, and its operation and function are described as follows:

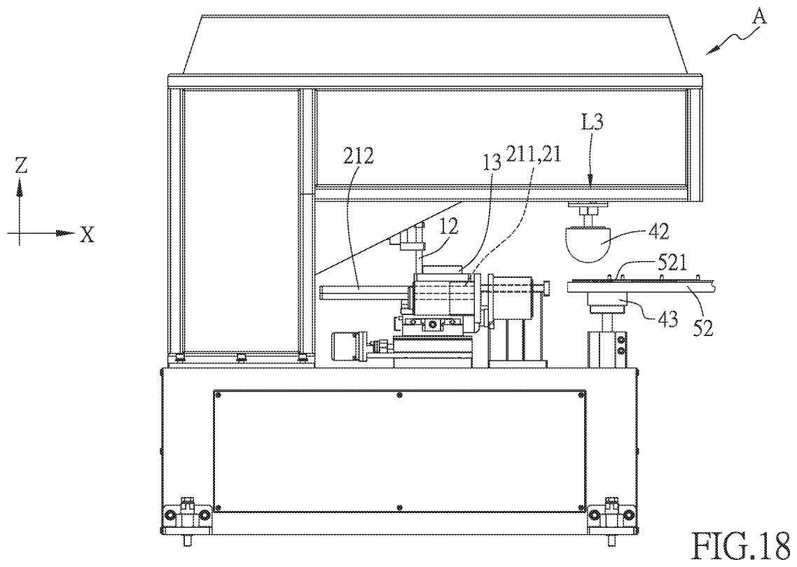

Referring first to FIGS. 1 and 18-21, the object N is placed on one of the positioning portions 521 of the turntable 52, then the turntable 52 rotates to a position aligned to the pad printing machine A, as shown in FIGS. 18-21, the drive motor 11 drives the ink-cup rack 12 to move to the transfer section 211 of the transfer plate 21 to pour ink into the cavity 211A. Then the transverse drive mechanism 411 drives the pad printing head 42 to move to the ink dip position L1, the height drive mechanism 412 then drives the pad printing head 42 to move towards the transfer plate 21 to soak the pad printing head 42 with the ink in the cavity 211A, then the pad printing head 42 moves upward to pad printing position L3 and then moves downward to come into contact with and print the ink onto the object N, then the pad printing head 42 moves upward to the cleaning position L2, and then the pad printing head 42 moves downward to come into contact with the cleaning tape S to clean the pad printing head 42.

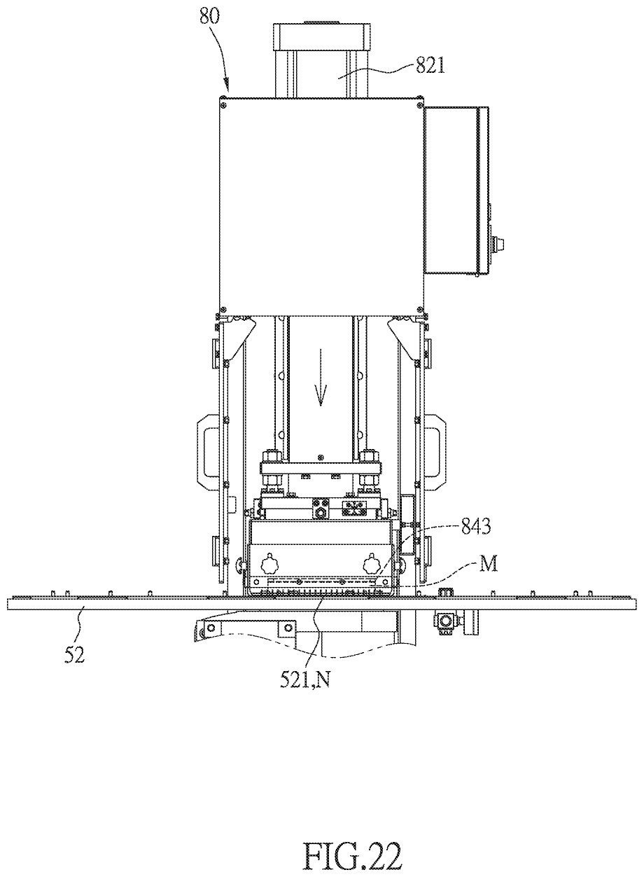

Referring then to FIGS. 1 and 5, the turntable drive source 511 rotates the turntable 52 to move the object N which has been printed with ink to a position aligned to the hot air generator 61, so as to dry the ink quickly with the hot air generated by the hot air generator 61. After that, the turntable 52 moves the semi-finished product printed with ink to a position corresponding to the imprint device 80, as shown in FIGS. 17 and 22, then the upper mould drive mechanism 82 drives the mould mounting mechanism 84 to move towards the object N printed with the ink and presses the mould M onto the object N printed with the ink, and then the high frequency machine 70 provides high heat energy converted from current to the object N printed with ink, so as to complete the moulding action. Meanwhile, the lower mould assembly 87 presses against the turntable 52 to prevent it from tilting unevenly.

Finally, repeat the abovementioned procedures in order to achieve automation, and it only needs to micro-adjust the processing positions of the pad printing machine A and the imprint device 80 before processing to align the pad printing position and the imprint position with the same parts of the positioning portions 521, so that the pad printing position and the imprint position can accurately fall in the same parts of the object N during processing.

Referring then to FIGS. 6-9, the controller 90 includes an automatic mode and a manual mode. During the automatic mode, the user uses the input device 91 to input the preset position information, the preset time duration information, the preset number of times information and the preset sequence information, these preset information are stored in different databases of the storage unit 921. The monitoring unit 922 monitors the ink cup mould 10, the cleaning mould 30 and the pad printing mould 40 to form the actual position information, actual time duration information, the actual number of times information, and the actual sequence information. The central control unit 923 compares the preset position information with the actual position information, the preset time duration information with the actual time duration information, and controls the pad printing mould 40 to make the actual position of the pad printing head 42 close to the preset position information and make the time duration in which the pad printing head 42 descends and waits close to the preset time duration information. The central control unit 923 further compares the preset number of times information with the actual number of times information, if the preset number of times information conforms with the actual number of times information, the central control unit 923 performs the corresponding subsequent operations. The central control unit 923 compares the preset sequence information with the actual sequence information and controls the ink cup mould 10, the cleaning mould 30 and the pad printing mould 40 to make the actual operation sequence conform with the preset sequence information.

When in the manual mode, the user can input value by using the input device 91, and use the central control unit 923 to directly control the ink cup mould 10, the cleaning mould 30 and the pad printing mould 40 to achieve the effect of test adjustment.

It is worth mentioning that the present invention fine-adjusts the rotation angle of the transfer plate 21 on the plane defined by the transverse and longitudinal directions X, Y, or the position of the transfer plate 21 in the transverse or longitudinal direction X,Y by using the three dimensional correction device 22, so that the transfer plate 21 can be accurately matched with the pad printing head 42.

From the foregoing, it can be seen that with the cooperation of the imprint device 80 and the turntable unit 50, the object N can be positioned in a fixed position during the process of imprint and the process of delivery before the imprint, so as to make the processing position more accurate while saving manpower.

Besides, the invention can clean the pad printing head 42 automatically by the cooperation of the cleaning mould 30 and the pad printing mould 40.

The invention can further adjust the high frequency current generated from the high frequency machine 70 by the adjustment device 722, so as to effectively control the output power.

In addition, by using the upper mould adjustment mechanism 83, the imprint device 80 can adjust the mould mounting mechanism 84 with respect to the upper mould drive mechanism 82 along the height, transverse and longitudinal directions Z, X, Y, so that the mould M can be precisely aligned to the positioning portion 521 of the turntable 52, so as to provide an imprint device capable of adjusting the imprinting position.

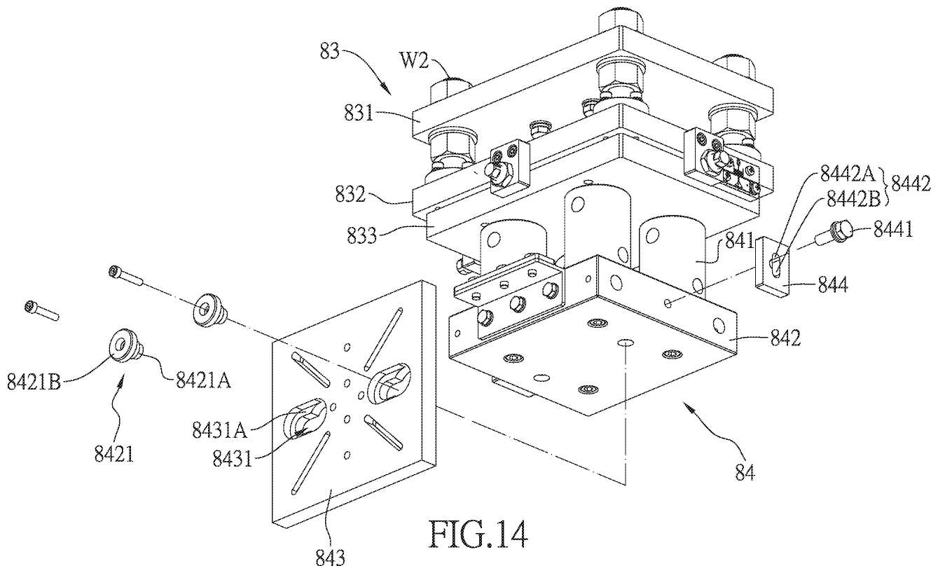

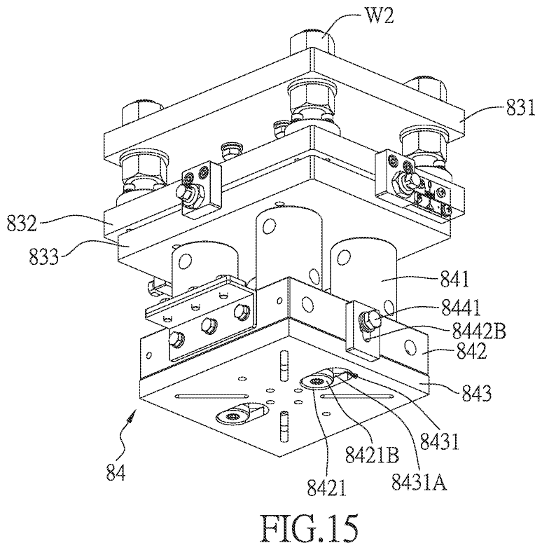

Referring then to FIGS. 14 and 15, with the arrangement of the quick release pins 8421 of the heating plate 842 and the engaging portions 8431A of the quick release holes 8431 of the mould mounting plate 843, the heating plate 842 and the mould mounting plate 843 can be disassembled and assembled quickly, so as to greatly improve the speed and convenience of replacing the mould.

As shown in FIGS. 14 and 15, by rotating the protection baffle 844, the heating plate 842 and the mould mounting plate 843 can be tightly abutted against the protection baffle 844 to prevent the mould mounting plate 843 from moving arbitrarily. Furthermore, the combination of heating plate 842 and mould mounting plate 843 is more stable, and the operation safety is improved.

Referring then to FIG. 13, the invention uses the lower mould drive mechanism 86 and the roller 871 to drive the lower mould plate 872 to move along the height direction Z, namely, the lower mould plate 872 can move along the height direction Z when the driving direction of the boost cylinder 861 is different from the moving direction of the lower mould plate 872. In this way, the boost cylinder 861 does not need to be set along the height direction Z, so as to reduce the height and volume of the imprint device 80, and make more efficient use of space.

While we have shown and described various embodiments in accordance with the present invention, it is clear to those skilled in the art that further embodiments may be made without departing from the scope of the present invention.

What is claimed is:

1. A shoe upper pad printing and moulding system, comprising:
a pad printing machine including a pad printer which includes: an ink cup mould, a transfer plate mould, and a pad printing mould, the ink cup mould including an ink-cup rack and an ink cup disposed on the ink-cup rack, wherein the ink-cup rack is able to move back and forth repeatedly along a direction, the ink cup is used to store ink;
the transfer plate mould includes a transfer plate which includes a transfer section and a standby section, the ink cup is located on a surface of the transfer plate, and repeatedly movable between the transfer section and the standby section, when the ink cup moves to the transfer section, the ink will be poured into the transfer section from the ink cup;
the pad printing mould includes a two dimensional drive device and a pad printing head which is fixed to and driven to move by the two dimensional drive device;
a turntable unit including a turntable drive group and a turntable, wherein the pad printing machine is arranged beside the turntable, the turntable includes a plurality of positioning portions provided for carrying an object, the turntable drive group drives the turntable to rotate;
a high frequency machine provided for outputting a high frequency current; and
an imprint device electrically connected to the high frequency machine, wherein the imprint device is located beside the turntable and includes: an imprint frame, an upper mould drive mechanism, and a mould mounting mechanism, the upper mould drive mechanism is fixed in the imprint frame, the upper mould drive mechanism is connected to and drives the mould mounting mechanism to move toward or away from the turntable, the mould mounting mechanism is provided for mounting a mould, thermal energy generated by the high frequency current is transmitted to the mould via the mould mounting mechanism;
by such arrangements, the pad printing head is driven by the two dimensional drive device to move to the transfer section to dip into the ink, and then moved by the two dimensional drive device to the positioning portions to print the ink onto the object, and then the turntable unit moves the object which has been printed with ink to allow the mould to perform imprinting.

2. The shoe upper pad printing and moulding system as claimed in claim 1, wherein the pad printing machine includes a bottom frame and a base frame, the base frame and the pad printer are mounted on the bottom frame, the ink cup mould and the pad printing mould are mounted on the base frame, the pad printer further includes a cleaning mould which includes a stationary platform mounted on the bottom frame, and two rollers pivotally disposed at two sides of the stationary platform, one of the two rollers is drivingly connected to and driven to rotate by a drive source, the two rollers are provided for mounting of a cleaning tape in such a manner that the cleaning tape extends from one of the two rollers to the stationary platform and then is connected to another of the two rollers, and the pad printing head moves to a position corresponding to the stationary platform during cleaning process.

3. The shoe upper pad printing and moulding system as claimed in claim 2, wherein the pad printing mould includes a support seat mounted on the bottom frame, so that the stationary platform is located between the support seat and the transfer plate.

4. The shoe upper pad printing and moulding system as claimed in claim 2, wherein a direction extending from the pad printing head to the transfer plate is defined as a height direction, the pad printing mould further includes a travel micro-adjustment device, a direction extending from the pad printing head to the transfer plate is defined as a height direction, a position of the transfer section is defined as an ink dip position, a position of the stationary platform is defined as a cleaning position, a position of the support seat is defined as a pad printing position, the travel micro-adjustment device is signally connected to the two dimensional drive device to control displacement amount of the pad printing head in the ink dip position, in the cleaning position or in the pad printing position along the height direction.

5. The shoe upper pad printing and moulding system as claimed in claim 2, wherein the transfer plate mould includes a three dimensional correction device, the transfer plate is located at one side of the three dimensional correction device and is driven to move by the three dimensional correction device, and the three dimensional correction device is capable of adjusting a position of the transfer plate, and also capable of controlling rotation of the transfer plate.

6. The shoe upper pad printing and moulding system as claimed in claim 5, wherein the three dimensional correction device includes a transverse displacement table, a longitudinal displacement table and a rotation micro-adjustment table which are arranged in a stacked manner, the transverse displacement table includes a first fixing portion, a first slide portion and a first drive device, the first fixing portion is fixed to the bottom frame, the first slide portion is able to move with respect to the first fixing portion along the transverse direction, the first drive device is drivingly connected to and drives the first slide portion to move along the transverse direction, the longitudinal displacement table is fixed to the first slide portion and includes: a second fixing portion, a second slide portion and a second drive device, the second fixing portion is fixed to the first slide portion, the second slide portion is able to move with respect to the second fixing portion along a longitudinal direction which is perpendicular to the transverse direction, the second drive device is drivingly connected to and drives the second slide portion to move along the longitudinal direction, the rotation micro-adjustment table is mounted on the second slide portion and includes: a base portion and a rotary portion rotatable with respect to the base portion, the base portion is fixed to the second slide portion, and the transfer plate is mounted on the rotary portion.

7. A shoe upper pad printing and moulding system, comprising:
a pad printing machine including a pad printer which includes: a transfer plate mould, and a pad printing mould, the pad printing mould including a transfer plate for providing an ink, the pad printing mould including a two dimensional drive device and a pad printing head which is fixed to and driven by the two dimensional drive device to move to the transfer plate to dip into the ink;
a high frequency machine including a high frequency generating system, wherein the high frequency generating system includes a high frequency generating device and a high frequency output member, and serves to produce high frequency waves which are outputted from the high frequency output member;
an imprint device including an imprint frame, an upper mould drive mechanism, an upper mould adjustment mechanism, a mould mounting mechanism, a lower mould drive mechanism and a lower mould assembly, wherein the upper and lower mould drive mechanisms are fixed in the imprint frame, a direction extending from the pad printing head to the transfer plate is defined as a height direction, the upper mould drive mechanism is connected to and drives the upper mould adjustment mechanism to move along the height direction, the upper mould adjustment mechanism is connected to the mould mounting mechanism and capable of adjusting a position of the mould mounting mechanism with respect to the upper mould drive mechanism;
the mould mounting mechanism includes a heating plate and a mould mounting plate, the heating plate is connected to the high frequency output member, the mould mounting plate is removably fixed to the heating plate and provided for mounting different moulds;
the lower mould drive mechanism is drivingly connected to and drives the lower mould assembly to move towards the mould mounting mechanism; and
a turntable unit including a turntable drive group and a turntable, wherein the pad printing machine and the imprint device are arranged beside the turntable, the turntable includes a plurality of positioning portions provided for carrying an object, and the turntable drive group drives the turntable to rotate.

8. The shoe upper pad printing and moulding system as claimed in claim 7, wherein the high frequency generating system further includes an adjustment device and a conduction member, the conduction member is connected to the high frequency generating device and the adjustment device, and serves to transmit high frequency waves generated by the high frequency generating device to the adjustment device, the adjustment device is connected to the high frequency output member to adjust output power.

9. The shoe upper pad printing and moulding system as claimed in claim 8, wherein the adjustment device includes: an output capacitor plate, an adjustable capacitor plate, a mobile device and a handwheel, the handwheel is connected to and drives the mobile device to move, the adjustable capacitor plate is connected to the mobile device, the conduction member is connected to the adjustable capacitor plate, by rotating the handwheel, the adjustable capacitor plate is controlled to move close to or away from the output capacitor plate, thereby controlling an output energy of the output capacitor plate, and the high frequency output member is connected to the output capacitor plate.

10. The shoe upper pad printing and moulding system as claimed in claim 7, wherein the upper mould adjustment mechanism includes: a first plate, a second plate and a third plate, the second plate is connected to and movable with respect to the first plate along the height direction, thus micro-adjusting a position of the second plate in the height direction, the second plate is fixed to the third plate and movable with respect to the third plate along a transverse direction and a longitudinal direction, the transverse and longitudinal directions are perpendicular to the height direction, the third plate is fixed to the mould mounting mechanism, so that the upper mould adjustment mechanism is able to micro-adjust a relative position between the mould mounting mechanism and the upper mould drive mechanism.

11. The shoe upper pad printing and moulding system as claimed in claim 10, wherein an adjustment bolt is inserted through the first plate and the second plate and screwed with an adjustment nut, rotating the adjustment nut can adjust a position of the second plate in the height direction.

12. The shoe upper pad printing and moulding system as claimed in claim 10, wherein the mould mounting mechanism includes a plurality of insulation cylinders connected to the heating plate and the third plate.

13. The shoe upper pad printing and moulding system as claimed in claim 7, wherein the heating plate includes two quick release pins, each of the quick release pins includes a neck portion and a head portion which has a diameter larger than a diameter of the neck portion, the mould mounting plate includes two elongated quick release holes, each of the quick release holes includes an engaging portion formed on an inner lateral surface of the quick release holes, when the mould mounting plate is fixed to the heating plate, the quick release pins are inserted in the quick release holes, by moving the mould mounting plate, the head portions of the quick release pins are engaged in the engaging portions.

14. The shoe upper pad printing and moulding system as claimed in claim 7, wherein the mould mounting mechanism includes a protection baffle fixed to the heating plate by a bolt, the protection baffle includes a slide slot, the bolt is inserted in the slide slot, the slide slot includes an insertion portion and a slide portion which is different in size from the insertion portion, when the mould mounting plate is assembled to the heating plate, the protection baffle is maintained in a vertical manner and abutted against the mould mounting plate and the heating plate simultaneously, and when the protection baffle rotates to a position where the protection baffle is abutted against the heating plate only, the mould mounting plate is allowed to be removed.

15. The shoe upper pad printing and moulding system as claimed in claim 7, wherein the lower mould drive mechanism includes: a boost cylinder, a push block and a slide rail, the boost cylinder is connected to and drives the push block to move, the push block is movably mounted on the slide rail, and includes a first section and a second section, the lower mould assembly includes a roller, a lower mould plate and two telescopic rods, the roller is pivoted to the lower mould plate and comes into contact with one surface of the push block which has another opposite surface attached to the slide rail, each of the two telescopic rods has two ends fixed to the imprint frame and the lower mould plate, respectively, the boost cylinder moves the push block until the first section comes into contact with the roller, then the roller pushes the lower mould plate upward, when the second section contacts the roller, the roller will pull the lower mould plate to move downward.
